(19) United States
(12) Patent Application Publication
(10) Pub. No.: US 2026/0105363 A1
(43) Pub. Date: Apr. 16, 2026

(54) AIML MODEL LIFE CYCLE MANAGEMENT

(71) Applicant: InterDigital Patent Holdings, Inc., Wilmington, DE (US)

(72) Inventors: Tejaswinee Lutchoomun, Montreal (CA); Yugeswar Deenoo Narayanan Thangaraj, Chalfont, PA (US); Ghyslain Pelletier, Montreal (CA); Oumer Teyeb, Montreal (CA)

(73) Assignee: InterDigital Patent Holdings, Inc., Wilmington, DE (US)

(21) Appl. No.: 19/105,106

(22) PCT Filed: Sep. 28, 2023
(86) PCT No.: PCT/US2023/075333

§ 371 Date: Feb. 20, 2025

Related U.S. Application Data
(60) Provisional application No. 63/410,983, filed on Sep. 28, 2022.
(60) Provisional application No. 63/456,831, filed on Apr. 4, 2023.

(51) Int. Cl. G06N 20/00; G06N 3/082

(52) U.S. Cl. CPC G06N 20/00; G06N 3/082

(57) ABSTRACT

A wireless transmit/receive unit (WTRU) comprising a processor configured to receive configuration information comprising information on one or more artificial intelligence/machine language (AIML) lifecycle management (LCM) stages associated with an AIML model and information on a local LCM stage reporting identification (ID) granularity and a global LCM stage reporting ID granularity for reporting on the one or more AIML LCM stages, transmit feedback for a first AIML LCM stage using the local LCM stage reporting ID granularity, receive an indication to switch to the global LCM stage reporting ID granularity, transmit an LCM stage reporting ID granularity switch confirmation message, and transmit feedback for a second AIML LCM stage using the global LCM stage reporting ID granularity.

### CROSS-REFERENCE TO RELATED APPLICATIONS

This application claims the benefit of U.S. Provisional Application No. 63/410,983, filed on Sep. 28, 2022, and 63/456,831, filed on Apr. 4, 2023, the entire contents of which are incorporated herein by reference.

### BACKGROUND

A WTRU using artificial intelligence/machine language (AIML) models may need to provide feedback relating to artificial intelligence/machine language (AIML) lifecycle management (LCM) stages (e.g., model training, model switching, model activation/deactivation) associated with the AIML models. Feedback on LCM stages of AIML models may provide for many different types and layers of data. A WTRU providing feedback on LCM stages may need to provide data at different granularities for different AIML models in different environments. What is needed are WTRU systems and methods that enable use of different LCM stage reporting ID granularities to provide feedback on AIML models at different levels of information.

### SUMMARY

A wireless transmit/receive unit (WTRU) may comprise a processor. The processor may be configured to receive configuration information comprising information on one or more artificial intelligence/machine language (AIML) lifecycle management (LCM) stages associated with an AIML model and information on a local LCM stage reporting identification (ID) granularity and a global LCM stage reporting ID granularity for reporting on the one or more AIML LCM stages, wherein the global LCM stage reporting ID granularity is configured to utilize a different amount of resources than the local LCM stage reporting ID granularity. The processor may be further configured to transmit feedback for a first AIML LCM stage for the AIML model using the local LCM stage reporting ID granularity. The processor may be further configured to receive an indication to switch to the global LCM stage reporting ID granularity for reporting on the one or more AIML LCM stages. The processor may be further configured to transmit an LCM stage reporting ID granularity switch confirmation message. The processor may be further configured to transmit feedback for a second AIML LCM stage for the AIML model using the global LCM stage reporting ID granularity.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2A is a schematic illustration of an example system environment implementing artificial intelligence (AI) and/or machine learning (ML) models.

FIG. 2B illustrates an example of a neural network.

FIG. 2C is a schematic illustration of an example system environment for training and/or implementing an AIML model that includes a neural network (NN).

FIG. 3 is a procedure diagram illustrating an example for indicating an AIML LCM stage reporting ID granularity.

FIG. 4 is a flow chart illustrating an example method for implementing an AIML LCM stage reporting ID granularity.

### DETAILED DESCRIPTION

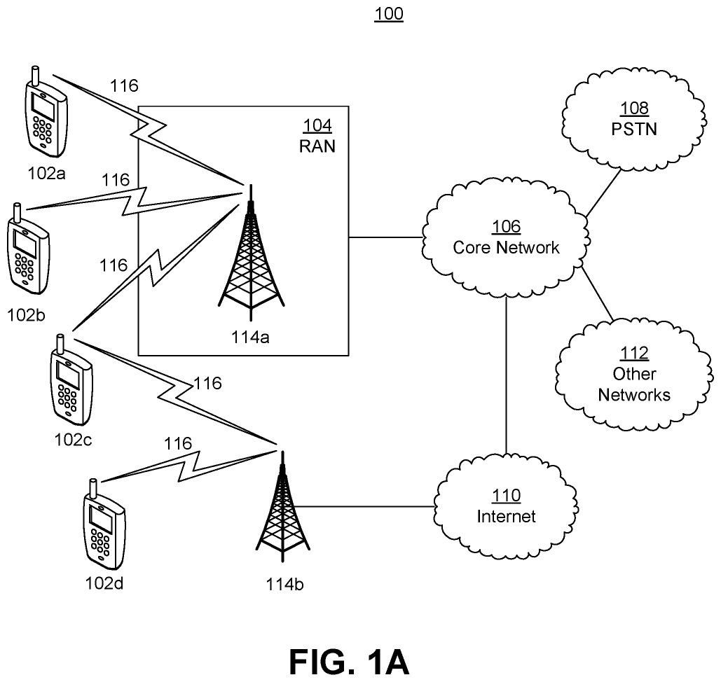

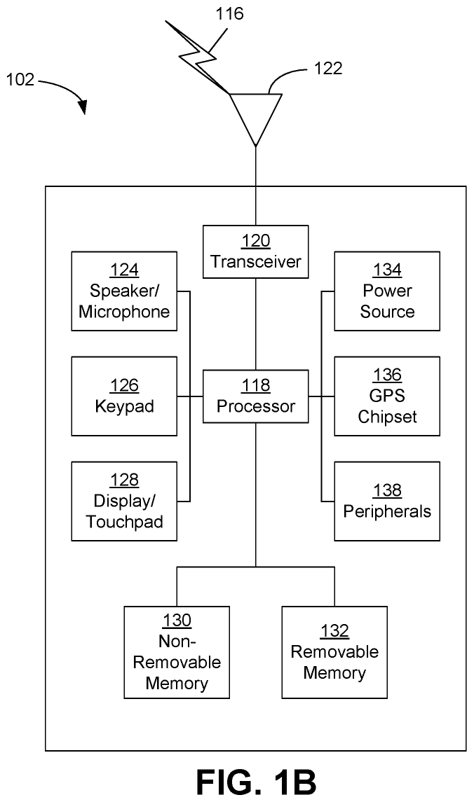

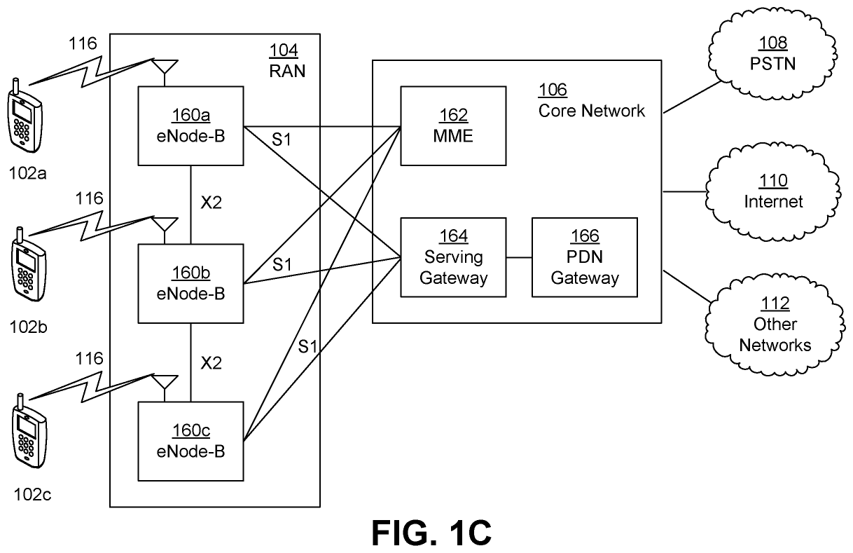

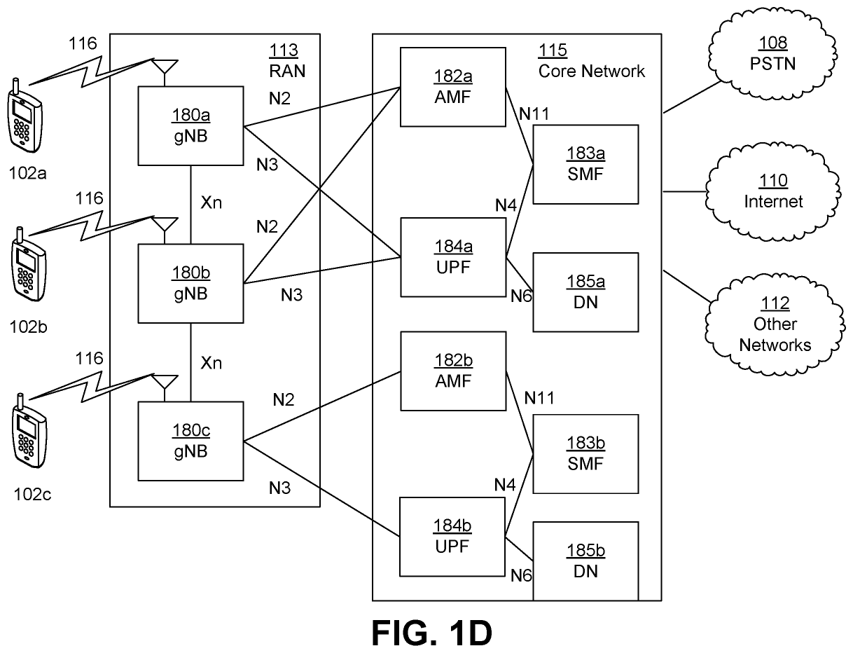

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

The following description is for exemplary purposes and does not intend to limit in any way the applicability of the methods described herein to any wireless technology and/or to other technology when applicable. The term network in this disclosure may refer to one or more gNBs, which in turn may be associated with one or more transmission/reception points (TRPs) or any other node in the radio access network.

The terms artificial intelligence (AI), machine learning (ML), deep learning (DL), and DNNs may be used interchangeably. Methods described herein are exemplified based on learning in wireless communication systems. The methods are not limited to such scenarios, systems, and services and may apply to any transmission and/or service type.

Throughout this disclosure, the terms “AIML model,” “AIML model,” “ML model,” and “model” may be used interchangeably to refer to an artificial intelligence/machine learning model that emulates logical decision-making based on available, collected, and/or requested data.

AI may be broadly defined as the behavior exhibited by machines that mimic the cognitive functions of sense, reason, adaptation, and action. Machine learning may refer to types of algorithms that solve problems based on learning through experience (‘data’) without explicitly being programmed (e.g., a configured set of rules). Machine learning may be considered a subset of AI. Different machine learning paradigms may be envisioned based on the nature of the data or feedback available to the learning algorithm. A supervised learning approach may involve learning a function that maps input to an output based on labeled training data, each training data example consisting of an input and a corresponding output pair. An unsupervised learning approach may involve detecting patterns in data without any pre-existing labels. For example, a reinforcement learning approach may involve performing a sequence of actions in an environment to maximize the cumulative reward.

It is possible to apply machine learning algorithms using a combination of an interpolation of the above-mentioned approaches. For example, a semi-supervised learning approach may use a combination of a small amount of labeled data with a large amount of unlabeled data during training. In this regard, semi-supervised learning falls between unsupervised learning (with no labeled training data) and supervised learning (with only labeled training data). Deep learning refers to a class of machine learning algorithms that employ artificial neural networks (DNNs) loosely inspired by biological systems. Deep Neural Networks (DNNs) are a special class of machine learning models inspired by the human brain, wherein inputs are linearly transformed and passed through non-linear activation functions multiple times. DNNs typically consist of multiple layers, each layer consisting of linear transformation and non-linear activation functions. DNNs may be trained using training data via a backpropagation algorithm. Recently, DNNs have shown state-of-the-art performance in a variety of domains (e.g., speech, vision, natural language, etc.) and for various machine learning settings, including supervised, unsupervised, and semi-supervised.

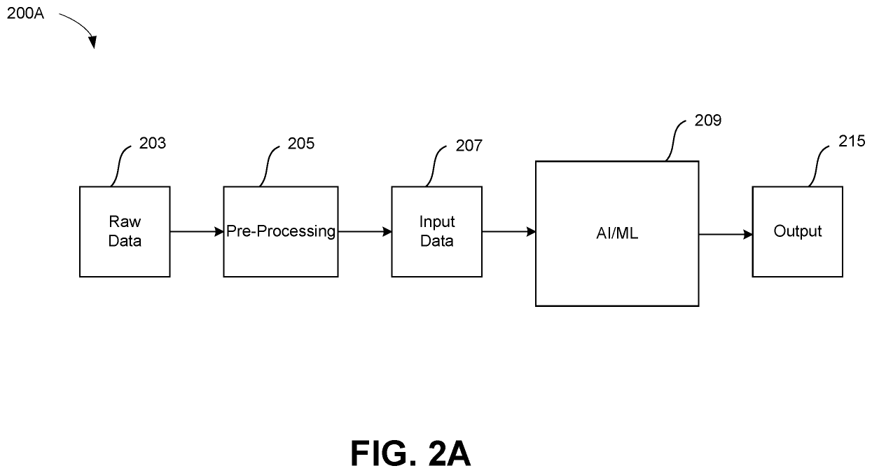

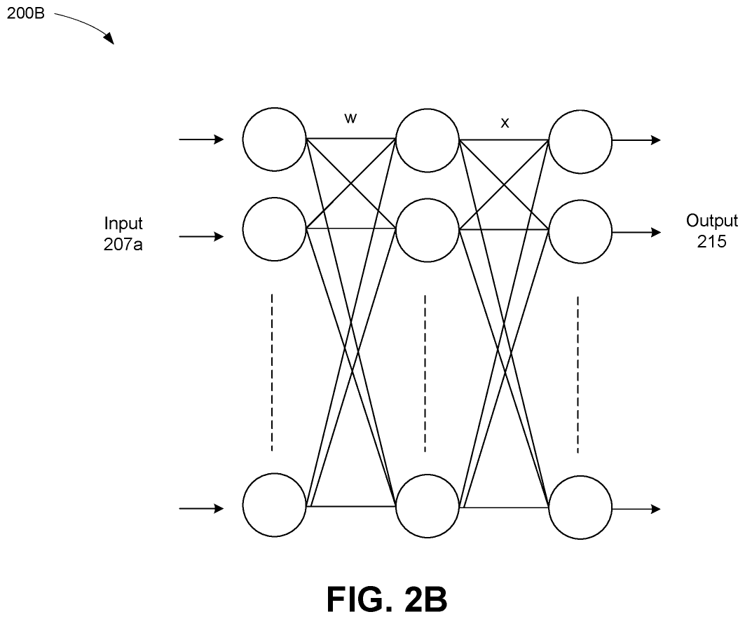

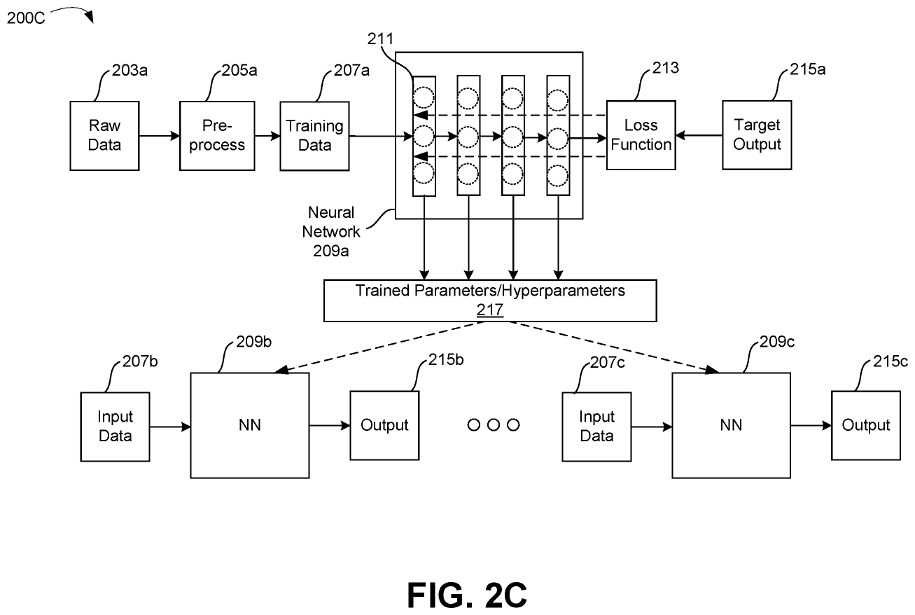

FIG. 2A is a schematic illustration of an example system environment 200A implementing an AIML model 209. The AIML model 209 may be implemented at the WTRU and/or the network. The AIML 209 model may include model data and one or more algorithms and/or functions configured to learn from input data 207 received to train the AIML model 209 and/or generate an output 215. The input data 207 may be inputted in one or more formats, such as an image format, an audio format (e.g., spectrogram or another audio format), a tensor format (e.g., including single-dimensional or multi-dimensional arrays), and/or another data type capable of being inputted into the AIML model 209 algorithms. The input data 207 may be the result of pre-processing 205 that may be performed on raw data 203, or the input data 207 may include the raw data 203 itself. The raw data 203 may include image data, text data, audio data, or another sequence of information, such as a sequence of network information related to a communication network and/or other types of data. The pre-processing 205 may include format changes or other types of processing to generate input data 207 in a format for input into the AIML 209 algorithms. The output 215 may be generated by the AIML model 209 algorithm in one or more formats, such as a tensor, a text format (e.g., a word, sentence, or other sequences of text), a numerical format (e.g., a prediction), an audio format, an image format (e.g., including video format), another data sequence format, and/or another output format.

AIML model 209 may be implemented as described herein using software and/or hardware. The AIML model 209 may be stored as computer-executable instructions on computer-readable media accessible by one or more processors for performing as described herein. Example AIML environments and/or libraries include TENSORFLOW, TORCH, PYTORCH, MATLAB, GOOGLE CLOUD AI and AUTOML, AMAZON SAGEMAKER, AZURE MACHINE LEARNING STUDIO, and/or ORACLE MACHINE LEARNING.

The AIML model 209 may include one or more algorithms configured for unsupervised learning. Unsupervised learning may be implemented utilizing AIML model 209 algorithms that learn from the input data 207 without being trained toward a particular target output. For example, during unsupervised learning, the AIML model 209 algorithms may receive unlabeled data as input data 207 and determine patterns or similarities in the input data 207 without additional intervention (e.g., updating parameters and/or hyperparameters). The AIML model 209 algorithms configured for implementing unsupervised learning may include algorithms configured for identifying patterns, groupings, clusters, anomalies, and/or similarities or other associations in the input data 207. For example, the AIML model 209 algorithm may implement hierarchical clustering algorithms, k-means clustering algorithms, k nearest neighbors (K-NN) algorithms, anomaly detection algorithms, principal component analysis algorithms, and/or apriori algorithms. The AIML model 209 algorithms configured for unsupervised learning may be implemented on a single device or distributed across multiple devices, such that the output 215, or portions thereof, may be aggregated at one or more devices for being further processed and/or implemented in other downstream algorithms or processes, as may be further described herein.

The AIML model 209 may include one or more algorithms configured for supervised learning. Supervised learning may be implemented utilizing AIML model 209 algorithms that are trained during a training process to determine a predictive model using known outcomes. The AIML model 209 algorithms may be characterized by parameters and/or hyperparameters that may be trained during the training process. The parameters may include values derived during the training process. The parameters may include weights, coefficients, and/or biases. The AIML model 209 may also include hyperparameters. The hyperparameters may include values used to control the learning process. The hyperparameters may include a learning rate, the number of epochs, the batch size, the number of layers, the number of nodes in each layer, the number of kernels (e.g., CNNs), the size of stride (e.g., CNNs), the size of kernels in a pooling layer (e.g., CNNs), and/or other hyperparameters. AIML models may use certain parameters and hyperparameters interchangeably.

The AIML model 209 may be trained during supervised learning by inputting training data to the AIML model 209 algorithm and adjusting the parameters and/or hyperparameters toward a known target output 215 while minimizing a loss or error in the output 215 generated by the AIML 209 algorithm. The raw data 203 may include or may be separated into training data, validation data, and/or test data for training, validation, and/or testing, respectively, of the AIML model 209 algorithms during supervised learning. The training data, validation data, and/or test data may be pre-processed from the raw data 103 for input into the AIML model 209 algorithm. During supervised learning, the training data may be labeled prior to input into the AIML model 209. The training data may be labeled to teach the AIML model 209 algorithm to learn from the labeled data and to test the accuracy of the AIML model 209 for being implemented on unlabeled input data 207 during production/implementation of the AIML model 209 algorithms, or similar AIML model 209 algorithms utilizing similar parameters and/or hyperparameters. The training data may be used to fit the AIML model 209 parameters using optimization functions, such as a loss or error function. The trained or fitted AIML model 209 may receive validation data as input to evaluate the model fit on the training data set while tuning the hyperparameters of the AIML model 209. The AIML model 209 may receive test data to evaluate a final model fit on the training data set and assess the AIML model 209 performance. One or more of the training, validation, and/or testing may be performed during supervised learning for different types of the AIML model 209.

Supervised learning may be implemented for various types of AIML model 209 algorithms, including algorithms that implement linear regression, logistic regression, neural networks (NNs), decision trees, Bayesian logic, random forests, and/or support vector machines (SVMs). NNs and Deep NNs (DNNs) are popular examples of algorithms utilized in AIML models that may be trained using supervised learning. However, the AIML model 209 may implement one or more NN and/or non-NN-based algorithms. Various examples of NNs may include perceptrons, multilayer perceptrons (MLPs), feed-forward NNs, fully-connected NNs, convolutional neural networks (CNNs), recurrent NNs (RNNs), long-short term memory (LSTM) NNs, and/or residual NNs (ResNets). A perceptron is a NN that includes a function that multiplies its input by a learned weight coefficient to generate an output value. A feed-forward NN is a NN that receives input at one or more nodes of an input layer and moves information in a direction through one or more hidden layers to one or more nodes of an output layer. In a feed-forward NN, one or more nodes of a given layer may be connected to one or more nodes of another layer. A fully connected NN is a NN that includes an input layer, one or more hidden layers, and an output layer. In a fully connected NN, each node in a layer is connected to each node in another layer of the NN.

An MLP is a fully connected class of feed-forward NNs. A CNN is a NN having one or more convolutional layers configured to perform convolution. Various types of NNs may have elements that include one or more CNNs or convolutional layers, such as Generative Adversarial Networks (GANs). GANs may include conditional GANs (CGANs), cycle-consistent GANs (CycleGANs), StyleGANS, DiscoGANs, and/or IsGANs. A GAN may include a generator sub-model and a discriminator sub-model. The generator sub-model may be configured to receive input data and pass true and independently generated data to the discriminator sub-model. The discriminator sub-model may be configured to receive the true and independently generated data from the generator, discriminate the true and independently generated data, and provide feedback to the generator sub-model during training to improve the function of the generator sub-model in independently generating an output based on a received input. The GAN is a popular model for generating data types or data sequences, such as image data, audio data, and/or text, for example. An RNN is a NN that is recurrent in nature, as the nodes include feedback connections and an internal hidden state (e.g., memory) that allows output from nodes in the NN to affect subsequent input to the same nodes. LSTM NNs may be similar to RNNs in that the nodes have feedback connections and an internal hidden state (e.g., memory). However, the LSTM NNs may include additional gates to allow the LSTM NNs to learn longer-term dependencies between data sequences.

A ResNet is a NN that may include skip connections to skip one or more layers of the NN. An autoencoder may be a form of AIML 109 that may be implemented for supervised learning, such that parameters and/or hyperparameters may be updated during a training procedure. The parameters and/or hyperparameters may relate to the encoder portion and/or the decoder portion of the autoencoder. NNs may include one or more attention layers or functions to enhance or focus on some portions of the input data while diminishing or de-emphasizing other portions.

Different types of NNs and/or layers may be implemented for processing different types of data and/or producing different types of output. For example, the NN may comprise one or more convolutional layers (e.g., for CNNs or GANs), which may be populated for processing image and/or audio data (e.g., spectrograms). Each convolutional layer may vary according to various convolutional layer parameters or hyperparameters, such as kernel size (e.g., field of view of the convolution), stride (e.g., step size of the kernel when traversing an image), padding (e.g., for processing image borders), and/or input and output size. The image being processed may include one or more dimensions (e.g., a line of pixels or a two-dimensional array of pixels). The pixels may be represented according to one or more values (e.g., one or more integer values representing color and/or intensity) that may be received by the convolutional layer. The kernel, which may also be referred to as a convolution matrix or mask, may be a matrix used to extract and/or transform features from the input data being received. The kernel may be used for blurring, sharpening, edge detection, and/or the like. An example kernel size may include a 3×3, 5×5, 10×10, etc., matrix (e.g., in pixels for a 2D image). The stride may be the parameter used to identify the amount the kernel is moved over the image data. An example default stride is of a size of 1 or 2 within the matrix (e.g., in pixels for a 2D image). The padding may include the amount of data (e.g., in pixels for a 2D image) added to the image data boundaries when the kernel processes it. The kernel may be moved over the input image data (e.g., according to the stride length) and perform a dot product with the overlapping input region to obtain an activation value for the region. The output of each convolutional layer may be provided to the next layer of the NN or provided as an output (e.g., image data, feature map, etc.) of the NN itself with the updated features based on the convolution.

The NN may include layers of a similar type (e.g., convolutional layers, feed-forward layers, fully-connected layers, etc.) and/or similar or different configurations (e.g., size, number of nodes, etc.) for each layer. The NN may also, or alternatively, include one or more layers having different types or different subsets of NNs that may be interconnected for training and/or implementation, as described herein. For example, a NN may include both convolutional layers and feed-forward or fully-connected layers.

FIG. 2B illustrates an example of a neural network 200B. The objective of training may be to apply the input 207a as training data and/or adjust one or more weights, indicated as w and x in FIG. 2B (e.g., which may be referred to as neuron weights and/or link weights), such that the output 215 from the neural network 20oB approaches the desired target values associated with the input 207a values for the training data. For example, a neural network may include three layers (e.g., as shown in FIG. 2B). During the training, for a given input, the difference between output and desired values may be computed, and/or the difference may be used to update the one or more weights in the neural network. If a significant (e.g., large) difference between output and desired value(s) is observed, for example, one or more relatively significant (e.g., large) changes in one or more weights may be expected. A small difference (e.g., between output and desired value(s)) may include one or more relatively small changes in one or more weights. For example, the input 207a may be reference signal parameters for positioning, and/or the output 215 may be an estimated position. The desired value may be location information acquired by a highly accurate global navigation satellite system (GNSS).

Once the neural network 200B completes its training, the difference between the output 215 and the desired values may be below a threshold. The neural network 200B may be applied or implemented after training for positioning by feeding input data 207a and/or by estimating or predicting the output 215 as the expected outcome for the associated input 207a. For example, the output 215 may be an estimated position and/or location of the WTRU.

Training a neural network 200B may include identifying one or more of the inputs for the neural network, the expected outputs associated with the inputs, and/or the actual outputs from the neural network against which the target values are compared.

For example, a neural network model may be characterized by one or more parameters and/or hyperparameters, which may include the number of weights and/or the number of layers in the neural network.

As used herein, the term “deep learning” may refer to a class of machine learning algorithms that employ artificial neural networks (e.g., deep neural networks (DNNs)) that were loosely inspired by biological systems and/or include at least one hidden layer. DNNs may be a special class of machine learning models inspired by the human brain where the input is linearly transformed and/or passes through a non-linear activation function one or more (e.g., multiple) times. DNNs may include one or more (e.g., multiple) layers where one or more (e.g., each) layer includes linear transformation and/or a given non-linear activation function(s). The DNNs may be trained using the training data via a backpropagation algorithm. Recently, DNNs have shown state-of-the-art performance in a variety of domains (e.g., speech, vision, natural language, etc.) and/or for various machine learning settings (e.g., supervised, unsupervised, and/or semi-supervised).

FIG. 2C is a schematic illustration of an example system environment 200C for training and implementing an AIML model that comprises an NN 200B. However, other types of AIML models (e.g., including NNs and/or non-NN models) may be similarly trained and/or implemented. The NN 200B may be trained and/or implemented on one or more devices to determine and/or update parameters and/or hyperparameters 217 of the NN 200B. Raw data 203a may be generated from one or more sources. For example, the raw data 203a may include image data, text data, audio data, or another sequence of information, such as a sequence of network information related to a communication network and/or other types of data. The raw data 203a may be pre-processed at 205a to generate training data 207a. The pre-processing may include formatting changes or other types of processing/(pre)filtering to generate the training data 207a in a format for input into the NN 200Ba.

The NN 200B may include one or more layers 211. The configuration of the NN 200B and/or the layers 211 may be based on the parameters and/or hyperparameters 217. As described herein, the parameters may include weights, coefficients, and/or biases for the nodes or functions in the layers 211. The hyperparameters may include a learning rate, a number of epochs, a batch size, a number of layers, a number of nodes in each layer, a number of kernels (e.g., CNNs), a size of stride (e.g., CNNs), a size of kernels in a pooling layer (e.g., CNNs), and/or other hyperparameters. As described herein, the NN 109a may include a feed forward NN, a fully connected NN, a CNN, a GAN, an RNN, a ResNet, and/or one or more other types of NNs. The NN 200B may comprise one or more different types of NNs or layers for different types of NNs. For example, the NN 109a may include one or more individual layers having one or more configurations.

During the training process, the training data 207a may be inputted into the NN 200B and may be used to learn the parameters and/or tune the hyperparameters 217. The training may be performed by initializing parameters and/or hyperparameters of the NN 200B, generating and/or accessing the training data 207a, inputting the training data 207a into the NN 200B, calculating the error or loss from the output of the NN 200B to a target output 215a via a loss function 213 (e.g., utilizing gradient descent and/or associated backpropagation), and/or updating the parameters and/or hyperparameters 217.

The loss function 213 may be implemented using backpropagation based gradient updates and/or gradient descent techniques, such as Stochastic Gradient Descent (SGD), synchronous SGD, asynchronous SGD, batch gradient descent, and/or mini-batch gradient descent. For example, loss or error functions may include functions for determining a squared-error loss, a mean squared error (MSE) loss, a mean absolute error loss, a mean absolute percentage error loss, a mean squared logarithmic error loss, a pixel-based loss, a pixel-wise loss, a cross-entropy loss, a log loss, and/or a fiducial-based loss. The loss functions may be implemented in accordance with one or more quality metrics, such as a Signal to Noise Ratio (SNR) metric or another signal or image quality metric.

An optimizer may be implemented along with the loss function 213. The optimizer may be an algorithm or function configured to adapt attributes of the NN 200B, such as a learning rate and/or weights, to improve the accuracy of the NN 200B and/or reduce the loss or error. The optimizer may be implemented to update the parameters and/or hyperparameters 217 of the NN 200B.

The training process may be iterated to update the parameters and/or hyperparameters 217 until an end condition is achieved. The end condition may be achieved when the output of the NN 200B is within a predefined threshold of the target output 215a.

After the training process is complete, the trained NN 200B, or portions thereof, may be stored for implementation by one or more devices. The trained NN 200B, or portions thereof, may be implemented in other downstream algorithms or processes, as may be further described herein. The trained NN 200B, or portions thereof, may be implemented on the same device on which the training was performed. The trained NN 200B, or portions thereof, may be transmitted or otherwise provided to another device for implementation. For example, the NN 209b, 209c may include one or more portions of the trained NN 200B. The NN 209b and NN 209c may receive input data 207b, 207c and generate respective outputs 215b, 215c. The output 215b, 215c may be generated in one or more formats, such as a tensor, a text format (e.g., a word, sentence, or another sequence of text), a numerical format (e.g., a prediction), an audio format, an image format (e.g., including video format), another data sequence format, and/or another output format. The output 215b, 215c may be aggregated at one or more devices for being further processed and/or implemented in other downstream algorithms or processes, as may be further described herein.

Alternatively or additionally, after the training process is complete, the trained parameters and/or tuned hyperparameters 217, or portions thereof, may be stored for implementation by one or more devices. The trained parameters and/or tuned hyperparameters 217, or portions thereof, may be implemented in other downstream algorithms or processes, as may be further described herein. The trained parameters and/or tuned hyperparameters 217, or portions thereof, may be implemented on the same device on which the training was performed. The trained parameters and/or tuned hyperparameters 217, or portions thereof, may be transmitted or otherwise provided to another device for implementation. For example, transmitted or otherwise provided to another device or devices that may implement the NN 209b, 209c based on the trained parameters and/or tuned hyperparameters 217. For example, the NN 209b, 209c may be constructed at another device based on the trained parameters and/or tuned hyperparameters 217 or portions thereof. The NN 209b and NN 209c may be configured from the parameters/hyperparameters 217, or portions thereof, to receive respective input data 207b, 207c and to generate respective outputs 215b, 215c. The output 215b, 215c may be generated in one or more formats, such as a tensor, a text format (e.g., a word, sentence, or another sequence of text), a numerical format (e.g., a prediction), an audio format, an image format (e.g., including video format), another data sequence format, and/or another output format. The output 215b, 215c may be aggregated at one or more devices for being further processed and/or implemented in other downstream algorithms or processes, as may be further described herein.

The AIML models and/or algorithms described herein may be implemented on one or more devices. For example, the AIML 209 may be implemented in whole or in part on one or more devices, such as one or more WTRUs, base stations, and/or other network entities, such as a network server. Example networks in which AIML may be distributed may include federated networks. A federated network may include a decentralized group of devices that each include AIML. As shown in FIG. 2C, the AIML model 209b and AIML model 209c may be distributed across separate devices. Though FIG. 2C shows two models (e.g., AIML model 209b and AIML model 209c), any number of models may be implemented across any number of devices. The AIML model may be implemented for collaborative learning in which the AIML model is trained across multiple devices. In another example, the AIML model may be trained at a centralized location or device, and one or more portions of the AIML model, or trained parameters and/or tuned hyperparameters, may be distributed to decentralized locations. For example, updated parameters or hyperparameters may be sent to one or more devices for updating and/or implementing the AIML model thereon.

A WTRU may be configured to perform an AIML model registration procedure. The AIML model registration procedure may include one or more capabilities. For example, the AIML model registration procedure may include the WTRU reporting its AIML capability, including support for different RAN functions for which AIML models may be supported by the WTRU, the number of AIML models supported, AIML processing capability, and the like. In another example, the AIML model registration procedure may include AIML model identity assignment or AIML model ID space configuration, in which the WTRU and/or the NW may address an AIML model without ambiguity during activation/deactivation, performance monitoring, training, etc. For example, the AIML model registration procedure may include AIML model verification, in which the WTRU may verify the integrity, compatibility, and/or applicability of AIML models.

The registration procedure may involve the exchange of one or more messages between the WTRU and gNB. The registration procedure may be executed during an RRC connection setup procedure (e.g., reusing RRC connection setup messages). The registration procedure may be executed during an RRC reconfiguration procedure (e.g., reusing RRC reconfiguration messages). The different parts of the registration procedure may be executed based on signaling at different protocol layers (e.g., a WTRU capability transmission via RRC messages and model activation/deactivation using MAC CE).

The WTRU may be configured with an AIML model registration context as an outcome of the model registration procedure. The model registration context may be a means to address, verify, configure, control, track, and manage the lifecycle management (LCM) stages of AIML models. The LCM stages of the AIML models may include model training, model monitoring, model switching, and model activation/deactivation.

The WTRU may be configured for AIML model capability exchange. The WTRU may determine the suitability of an AIML model through a capability exchange, which may be done in a semi-static way (e.g., during RRC configuration or reconfiguration) or prior to a model transfer anytime a node (WTRU and/or gNB) requests a model. Model capability exchange may include any one or more of WTRU capabilities, model type, the number of models, WTRU traffic type, measurements, comparison with legacy function, information about expected KPI (performance, latency, FLOPs) of the ML model, additional information about inputs to model, inference-related capabilities (e.g., FLOPs—FLOating Point operations), and training-related capabilities (e.g., FLOPs—FLOating Point operations), AIML hardware specific information, and including the model switch delay. The WTRU and NW may be able to negotiate the best configuration for the coexistence of AIML inference for multiple RAN functions.

The WTRU capabilities may include, for example, antenna configuration, numerology (e.g., SCS, waveform), number of Tx/Rx chains, whether the WTRU supports FDD/TDD/XDD/full duplex/half-duplex, and/or the number of panels. The WTRU may determine if an AIML model is suitable to perform at least one of its capabilities.

The WTRU may support at least one model type, including DNN, UNN, CNN, RNN, transformer, and/or autoencoder. The WTRU may determine if an AIML model is suitable if it uses a model type that the WTRU supports. The WTRU may indicate the type of layers and activation functions supported. The WTRU may indicate different model formats supported (e.g., ONNX—Open Neural Network Exchange, and the like).

The WTRU may be configured with a plurality of AIML models. The models may be developed offline by the WTRU vendor. The WTRU may support different AIML models for different RAN functions. For example, AIML models may support such RAN functions as CSI feedback compression/prediction, beam prediction, and positioning. The WTRU may support more than one AIML model for each RAN function. Each AIML model may be optimized for a specific operating context for the RAN function. Specific operating context herein may refer to different scenarios and/or configurations associated with the RAN function. The WTRU may indicate as part of its capability the maximum number of models it may support. For example, the maximum number of models the WTRU may support may be based on a function of the model size and limited by storage/memory size at the WTRU.

The WTRU may determine if an AIML model is suitable if it is applicable to the WTRU's traffic type. The traffic type may be defined or include at least one of periodic/aperiodic, burst start/end/duration, reliability, latency, throughput, and/or the like.

The WTRU may indicate its capability in terms of supported measurements, including the types of measurement, the frequency of measurements, and the supported measurement bandwidth. Such measurements may be used as inputs to AIML models. Such measurements may be used to monitor the performance of the AIML models. For example, a WTRU may be configured with resources on which to perform at least one measurement. The WTRU may compare at least one measurement to at least one threshold. At least one threshold may be configurable. If at least one measurement is greater or less than the at least one threshold, the WTRU may determine that a model is suitable. A model may be associated with at least one measurement threshold. A WTRU function may be associated with at least one measurement threshold. For example, the measurement may include at least one of position, velocity, the direction of mobility, L1 or L3 measurements such as L1-RSRP, RSSI, RSRQ, SINR, CO, RI, CQI, PMI, LI, interference measurement, Doppler, Doppler spread, delay spread, number of multipaths, coherence time, coherence bandwidth, beam direction, beamwidth, set of beams, path loss, a determination as to whether the path is line of sight or non-line of sight, throughput, BLER, and/or latency.

The WTRU may compare the performance of the AIML model on a function with the expected performance of using a baseline (e.g., non-AIML) method to perform the function. A WTRU may determine a rate of error events resulting from using the AIML model. An error event may be determined when the difference between the output of the AIML model and a baseline method is greater than or less than a threshold value. The WTRU may determine the suitability of the AIML model if the rate of error events is greater than or less than a threshold. The WTRU may determine the suitability of the AIML model if the difference between the output of the AIML model and the baseline model is greater than or less than a threshold.

The WTRU may be configured to determine the suitability of the ML model based on the number and/or type and/or size of inputs to the ML model. For example, one ML model may require more reference signals (e.g., CSI-RS resources) and/or reference signals at a higher frequency during the training procedure using local data than the WTRU may be able to support. For example, one AIML model may require inputs of a larger size (e.g., more granular multiple-bit location information) versus another ML model that may require a single-bit location indication. The WTRU may be configured to determine the suitability of the ML model based on RS configurations supported for inference. The WTRU may be configured to determine the suitability of the ML model based on an indication of different capabilities for inputs for model training and model inference.

The WTRU may be configured to determine the suitability of the ML model based on capabilities that may include computational complexity, inference latency, the storage required for the models, and/or other inference-related capabilities. Moreover, the WTRU may be configured to determine the suitability of the ML model based on how many inference instances may be run in parallel.

The WTRU may be configured to determine the suitability of the ML model based on capabilities that may include computational complexity, training latency, storage required for the models, frequency of model updates, and other training-related capabilities.

The WTRU may be configured to determine the suitability of the ML model based on how many training instances may be run in parallel. The WTRU may be configured to determine the suitability of the ML model based on how much inference and training may coexist and function together in the WTRU at any given time.

The WTRU may be configured to determine the suitability of the ML model based on the WTRU and NW being able to negotiate the best configuration for the coexistence of AIML inference for multiple RAN functions. For example, the gNB may indicate to the WTRU the function/corresponding ML model to prioritize in the presence of multiple ML models carrying out different functions.

The WTRU may be configured to determine the suitability of the ML model based on the type of hardware environment, AIML execution environment, memory availability, and other hardware specific information. Such configuration may be abstracted and may be indicated as a scaling factor compared to a predefined reference model.

The WTRU may be configured to determine the suitability of the ML model based on the model switch delay (e.g., the time taken to switch inference from one model to another). A model switch delay may be a function of AIML size, supported RAN function, and the like.

The WTRU may be configured for AIML model verification. For example, the WTRU may be configured to perform model verification before using the model for inference and/or training. Model verification may be a part of the registration procedure.

The WTRU may perform the model verification. For example, the WTRU may be configured to verify if the one-sided AIML model is ready for inference and/or training.

The WTRU and gNB may jointly perform the model verification. For example, the WTRU and gNB may perform model verification jointly via a signaling exchange to verify that the models at the WTRU and gNB are ready. The model verification may involve one or more of integrity, compatibility, and/or interoperability.

The WTRU may be configured with an AIML model by the network (NW) that requires an integrity check. The WTRU may be configured to check the integrity of the received AIML model. For example, the WTRU may be configured to calculate the checksum over the AIML model parameters using a preconfigured hash function. The WTRU may compare the checksum with the associated checksum of the AIML model. If the checksum doesn't match, the WTRU may indicate an integrity failure to the network.

The WTRU may be configured with an AIML model by the network that requires a compatibility check. The WTRU may be configured to verify if it may use the AIML model configured by the network. The WTRU may indicate to the network if the configured AIML model may be used for inference and/or training at the WTRU. For example, the WTRU may be configured to perform compatibility checks on the configured model, including whether the WTRU supports the configured AIML model format, whether the configured AIML model exceeds the WTRU capability, and/or whether the configured AIML model may be compiled to WTRU specific target execution environment.

The WTRU may be configured to verify the AIML model used by the WTRU is interoperable with the gNB. The WTRU may be configured with an AIML model that works jointly with the gNB model (e.g., in the CSI compression use case). For example, the WTRU may be configured to verify if the encoder model at the WTRU is interoperable with the decoder model at the gNB model, such that the gNB may reconstruct the CSI feedback sent by the WTRU.

The WTRU may be configured for AIML model identity assignment. The WTRU may be configured with one or more rules and/or configurations associated with AIML model identity. The WTRU may be configured for AIML model identity assignment during the AIML model registration procedure. If the model verification is successful, the WTRU may be configured for AIML model identity assignment. The WTRU may be configured for AIML model identity assignment for the AIML models for which the model verification is successful. The WTRU may receive explicit identity for the AIML models. The WTRU may receive a configuration of rules to determine the identity of AIML models within a preconfigured identity space. The registration procedure may create addressable assignments for AIML models at the WTRU. The registration procedure may create addressable assignments for AIML models configured to be used in the future based on gNB.

The WTRU may be configured with an AIML model identity that is in part implicitly or explicitly associated with one or more of the following: an identity of the NW vendor, an identity of the WTRU vendor, an identity of the cell, an identity of the operator; an identity of gNB, CU or any other RAN node or CN node; an identity of the logical area; an architecture of the model; hyperparameters of the model; an identity based on a reference to previously used ML model between WTRU and gNB; security context of the WTRU; an identity associated with training data and/or test data used to train the model; a model identity associated with a model structure or model parameters (including the learned parameters); an identity associated with RAN function or use case; an identity associated with model training instance; and an identity associated with scenario and/or configuration.

The identity of the NW vendor may be a logical identity defined within the identity space of an operator.

The identity of the NW vendor may be a globally unique ID.

The identity of the cell may be unique within a preconfigured logical area. The identity of the cell may be a globally unique identity. For example, the identity of the cell may be a mobile network code (MNC).

The identity of the operator may include one or more of a mobile country code (MCC,) MNC, and the like.

The identity of the logical area may include, for example, a RAN area, a tracking area, or the like.

The architecture of the model may include, for example, RNN, CNN, DNN, autoencoder, GAN, transformer, and the like.

Hyperparameters of the model may include, for example, the number of layers, activation function, learning rate, and the like.

The identity associated with RAN function or use case may include, for example, different logical identifiers that may be assigned to CSI feedback, beam management, positioning, mobility management, and the like.

The identity associated with the model training instance may include, for example, version ID or variations thereof.

The identity associated with a scenario and/or configuration may include, for example, channel model, bandwidth configuration, and the like.

A model ID structure may include model ID levels and/or granularities, each level and/or granularity defining different types and/or degrees of information and requiring different amounts of resources. The model ID structure may include model ID levels in which a first level may carry basic information while other levels add extra information. For example, level 1 (e.g., first granularity) may include essential, basic, and/or required information of the model version ID required to identify a model, which may be assigned by gNB and/or WTRU. The model may be assigned within a model ID space configured by gNB and/or following a handshake with the gNB. For example, other levels may include levels 2, 3, . . . , N (e.g., second . . . N granularity) in which any additional information as part of the model ID to identify a model is included in one or more of these levels or granularities. The additional information may be optional or mandatory. The additional information may correspond to any one or more of RAN function/sub function, use case, scenario, configuration, training, and a layer group within a corresponding model. The additional information may correspond to one or more AIML LCM stages associated with an AIML model.

The AIML model ID may include information on the model identity or parts thereof and associations between a model (or part thereof) and one or more other models (or part thereof). The function to model mapping may be one-to-one, many-to-one, and one-to-many. In one-to-one mapping, the function to model mapping may be one-to-one. In one-to-one mapping, a version model ID assigned to one model corresponds to the one function performed by the model. The one function performed by the model may be incorporated into the model version ID.

A mapping table at the gNB may assign different functions a unique ID. For example, CSI prediction may correspond to ID #1, beam prediction may correspond to ID #2, etc. The gNB may share the mapping table with the WTRU (e.g., semi-statically in RRC configuration/reconfiguration). The model function may correspond to one field in the model version ID. The node (e.g., WTRU or gNB where the model currently resides) may share the model version ID, which explicitly indicates the function carried out by the model. The model function corresponding to the lookup table may be indicated by the node (e.g., WTRU or gNB where the model currently resides) in addition to the model version ID (e.g., the function may not be incorporated into the model version ID). Additionally or alternatively, in one-to-one, any training/re-training of the model or part thereof may update the model version ID or part thereof.

In one-to-many, a single model identity may be applied to more than one model, for example, in federated learning scenarios.

In many-to-one (e.g., different identities for different layers/layer groups), a model ID may include, for example, [Model ID] [layer group1 ID] [Layer group2 ID]. In many-to-one, the layer grouping could be based on a function (e.g., beam prediction vs. beam blockage prediction) or configuration.

In one or more cases, the model ID may be associated with a binary model that may be compiled and optimized to specific WTRU hardware. In one or more other cases, the model ID may be associated with a model structure and/or parameters. For example, the model structure and/or parameters may be defined in a proprietary format. In another example, the model structure and/or parameters may be defined in a standardized format (e.g., 3GPP or an open format like ONNX). In one or more cases, the model ID may be associated with a logical model. For example, the logical model may be a functionality of a model. For example, the logical model may refer to the input and output relationship of a model. In another example, the logical model may refer to the dataset used to train a model. In another example, the logical model may refer to a training instance or outcome. In another example, the logical model may refer to model pairing between encoder and decoder of a two-sided model.

The model version ID may or may not include configuration and/or information about the number of layers (e.g., N1) that are updated out of the total number of layers (e.g., N). Information about the layers (e.g., number of layers, group of layers performing one function, number of functions performed by model, or part thereof) may not necessarily form part of the model version ID. For example, information about the layers may be transmitted with the model (e.g., as part of a model profile).

Information about the layers may be incorporated into the version ID. For example, the WTRU may be configured to perform training and update a portion of the AIML model (e.g., the number of layers (i.e., N-N1) that are unchanged/frozen and a number of layers (i.e., N1) whose weights may be updated as a result of training). For example, the received AIML model may have N layers. The low-level features extracted by the first (N-N1) layers may be directly suitable for the WTRU and may not require re-training, and the weights of these layers may be kept frozen for the training process. The remaining N1 layers may require re-training by the WTRU, and these weights may be updated during the fine-tuning or re-training process at the WTRU based on the data locally available at the WTRU. The choice of the parameters indicating how many layers may be directly utilized by the WTRU and how many will require re-training may be indicated to the WTRU by the gNB. For example, the number of layers may be indicated explicitly (e.g., an indication to train layer group1 corresponding to the first N1 layers) and/or implicitly (e.g., a request to use the AIML model for beam prediction in a joint beam and blockage prediction model). The choice of the parameters indicating how many layers may be directly utilized by the WTRU and how many will require re-training, may be determined by the WTRU based on one or both of the functions of the AIML model required for the WTRU (e.g., RAN function/subfunction) and the configuration of the model (e.g., [Model ID] [layer group1 ID] [Layer group2 ID]).

The WTRU may be configured to implicitly determine an identity of an AIML model or version thereof. The WTRU may be configured to determine the identity of an AIML model based on a hash of learned parameters. A mechanism to derive a unique identity for the AIML model may be defined to ensure proper synchronization between encoder and decoder. For some applications, the AIML model may become very large. A mapping between learned parameters and version ID may be created. For example, the WTRU may be configured to derive the identity (version) of the AIML model using any one or any combination of hashing over the learned parameters that are quantized (e.g., reduce the bits per weight and/or bias), hashing over the statistic of learned parameters (e.g., sum/mean/variance all the weights per neuron and/or layer), hashing over the learned parameters that are filtered (e.g., hash over few selected weights, last few layers, activations above a threshold, etc.), and/or hashing over a delta of learned parameters with respect to a reference model. The reference model may be one or more of a predefined model with standardized weights and biases, an AIML model as a result of offline training, and/or a previously synchronized AIML model between WTRU and gNB.

The WTRU may be configured to determine the identity of a AIML model based on training data. For example, the WTRU may be configured to determine an identity for the set of training data and/or test data. For example, the WTRU may be configured to determine an identity of the last training and/or test data. For example, the WTRU may be configured to determine the time of the last training and/or reception/generation of test data.

The WTRU may be configured with a link between a preconfigured identity space and a reference model. The WTRU may use a portion of the identity space to indicate different versions and, in some cases, based on different conditions. The WTRU may be configured to assume a preconfigured identity (e.g., 0) to a reference model. The WTRU may be configured to increment the identity by a predefined value (e.g., 1) during the online training procedure.

The WTRU may be configured to update an identity based on one or more conditions. For example, the WTRU may be configured to increment the identity by a predefined value for each successfully completed training procedure. The WTRU may be configured to increment the identity by a predefined value for each training data sample. The WTRU may be configured to increment the identity by a predefined value for each stochastic gradient descent batch. The WTRU may be configured to increment the identity by a predefined value for each epoch of training procedure. The WTRU may be configured to increment the identity by a predefined value upon successful AIML model synchronization with the gNB. The WTRU may be configured to increment the identity by a predefined value for each update of the learning parameters. The WTRU may be configured to increment the identity by a predefined value upon a timer expiration. The WTRU may be configured to increment the identity by a predefined value upon preconfigured threshold reduction in loss function (e.g., based on performance in intermediate KPI or end-to-end KPI). The WTRU may be configured to determine different levels of version updates based on complete convergence versus partial convergence.

The WTRU may be configured to explicitly determine an identity of a AIML model. The WTRU may be configured to determine the identity of the AIML model based on explicit signaling. The WTRU may be configured to apply the identity of the AIML model based on explicit signaling. The WTRU may be configured to apply the identity of the ML model based on explicit signaling by the gNB. The WTRU may be configured to apply the identity of the ML model based on explicit signaling during a training procedure. The WTRU may be configured to apply the identity of the AIML model based on explicit signaling during one or more steps. The WTRU may be configured to apply an identity of the AIML model based on a WTRU vendor configuration. The WTRU may be configured to apply an identity of the AIML model based on a default configuration specified in a standard.

In one or more cases, the WTRU may be configured with one or more AIML models and global IDs of those models. For example, the WTRU may receive such configuration from the WTRU vendor. In some examples, the WTRU may receive the configuration from the WTRU vendor during an implementation or via OTT signaling. In one or more cases, the WTRU vendor may inform (e.g., register) the one or more AIML models with the NW vendor. The WTRU vendor may indicate the one or more AIML models via, for example, but not limited to, long with global IDS, optional metadata associated with the models, and the like. In one or more cases, the network (NW) vendor may configure/provide the information corresponding to the global IDs to the OAM entity and/or gNB.

The WTRU may be configured to indicate to the gNB/network the list of global IDs of models supported by the WTRU. For example, the WTRU may indicate the global IDs in a list/sequence {G1, G2, G3 . . . Gn}. In one or more cases, the WTRU may transmit the indication of the global IDs via WTRU capability signaling. For example, the WTRU may transmit the indication of the global IDs during a registration procedure. Additionally or alternatively, in another example, the WTRU may transmit the indication via RRC or NAS signaling.

In one or more cases, the WTRU may receive a configuration from the gNB/network that indicates one or more allowed models. For example, the allowed models may be indicated via a Boolean field with reference to the supported model list transmitted by the WTRU. For example, the allowed models may be configured as a list {1, 0, 1 . . . 0}. For example, 0 may indicate the model is not allowed. As another example, 1 may indicate that the model is allowed. Additionally or alternatively, models, for example, corresponding to global IDs G1 and G3, are allowed, and the remaining global IDs are not allowed. In one or more cases, the WTRU may derive a local ID for allowed models as follows. For example, for each allowed model in the list, the WTRU may start with an initial local ID (e.g., 0 or preconfigured by the gNB/NW) for the first allowed model and sequentially increment a model ID for each allowed model in the list. In one or more cases, the WTRU may be configured with a different initial local ID for different use cases. In one or more cases, the WTRU may be configured to attach a use case specific ID to the local ID. In one or more cases, the WTRU may receive an explicit assignment for the local ID from the gNB/NW. For example, the WTRU may receive a model transfer from the NW, and the WTRU may receive a local ID during the model transfer.

In one or more cases, the WTRU may receive an indication from the gNB/network on the list of acquirable models. For example, the gNB may have information from the WTRU vendor about a model that is not yet available at the WTRU. The WTRU may receive a list of global IDs associated with the acquirable models. Upon receiving the list of acquirable models, the WTRU may trigger the model transfer of these models from a server. For example, the WTRU may trigger the model transfer of these models from a server, such as, but not limited to, a WTRU vendor server, a non-3GPP entity, a CN entity, and the like. In one or more cases, the WTRU may be configured to indicate to the gNB/network when the download of one or more models in the acquirable list is complete. The WTRU may indicate when the download is complete via one or more of WTRU capability signaling, a model update procedure, or a registration procedure.

In one or more cases, the WTRU may be configured with a model ID or a part thereof as a function of a task. In one or more cases, the WTRU may be configured with more than one type of model ID, in which the type of model ID that the WTRU determines to use may be a function of the task at hand. In one or more other cases, the model ID may include multiple parts, in which the part used by the WTRU may be a function of the task at hand. For example, a part of the model ID may include a static versus dynamic model ID or part thereof. In another example, a part of the model ID may include a WTRU-specific versus model specific model ID or part thereof. In another example, a part of the model ID may include a global versus local model ID or part thereof. For instance, one or more levels (e.g., those described herein as components of AIML model identity) may correspond to the global part, whereas one or more other levels may correspond to the local part. In another instance, a local model ID may correspond to one cell. In yet another instance, the local model ID may correspond to a group of cells/tracking area and the like. In another example, a part of the model ID may include a frozen versus trainable model ID or part thereof.

In one or more cases, the WTRU may be configured with rules that define which model ID or part thereof is to be used for which task. For example, to provide capability indication (e.g., providing an indication to another cell), the WTRU may use the global model ID or part thereof. In another example, to provide capability indication (e.g., providing an indication to the same cell after a long period of inactivity/after transitioning from an idle state), the WTRU may use the local model ID or part thereof. In another example, for model transfers (e.g., from the WTRU to gNB or another WTRU via SL), the WTRU may use the global model ID or part thereof. In another example, for model training/retraining/fine-tuning (e.g., based on local data), the WTRU may use a local model ID or part thereof. In another example, for model switching (e.g., based on poor model performance measured by the WTRU or indicated to the WTRU by NW), the WTRU may use a local model ID or part thereof.

In one or more cases, the WTRU may be configured with an association between multiple granularities of model ID and/or rules on how to convert the model ID. The association may correspond to a mapping table associating one type of model ID to another. For example, the mapping table may associate a mapping global model ID to a local model ID and/or vice versa. The mapping table may, for example, include rules/configurations for the WTRU to convert between two or more formats of model ID. For example, the rules/configurations may correspond to converting the model ID from local to global or vice versa. For instance, rules/configurations may include removing a field with information corresponding to the cell ID to convert a model ID from ‘local’ to ‘global.’ In another example, rules/configurations may include adding a field with information on the tracking area/group of cells to convert a model ID from ‘global’ to ‘local’ and, in this case, from local to a group of cells. In another instance, rules/configurations may include converting from global to local or vice-versa, which may change the format of the model ID (e.g., in a case where a cell ID may be scrambled with the existing fields in the global model ID to make the model ID local). In such cases, the WTRU may be configured with an association/mapping table to convert between the two types of model IDs.

In one or more cases, the WTRU may report a start/end of an LCM component to the network. The start/end of the LCM component may include, for example, but is not limited to, a start/end of training/retraining, completion of model switching, and the like. In one or more cases, the WTRU may report to the network the start/end of the LCM component using one type of model ID. In some cases, the network may determine that the granularity of reporting is not providing sufficient details and may request for the WTRU to increase the granularity of reporting. For example, the format of a local model ID may be shorter compared to the format of a global model ID, which may provide additional information to the network. The additional provided information may include, for example, but is not limited to, training parameters, such as a number of iterations before convergence, training time, and the like. In some cases, the WTRU may start reporting the end of training using the local model ID due to lower overhead. The WTRU may receive a request from the network to report future training-related processes (e.g., start/end of training) using the global model ID that includes additional parameters on the training. The WTRU may switch from a local model ID to a global model ID to report the start/end of any subsequent process related to model training. In one or more cases, the WTRU may receive a configuration from the network on the granularity on which to report a start/end/milestones for each process. The start/end/milestones for each process may include, for example, but are not limited to, an end of training, a start of model monitoring, a percentage (e.g., 80%) of model training completed, and the like. In one or more cases, the WTRU may receive resources and/or configuration(s) from the network to enable the reporting on the granularity specified by the network. In one or more cases, the network may update the reporting granularity at any point in the process and send an indication to the WTRU.

The WTRU may be configured to determine a configuration of registered AIML models for inference. An initial AIML model configuration may be done at the gNB. The gNB may have an initial set of AIML models which may be gNB-specific, area-specific, and/or global. The gNB may configure the AIML models for inference. The gNB may train the AIML models based on datasets at the gNB. The WTRU may receive requests from the gNB to report on some parameters (e.g., send CSI reports, beam indices corresponding to best Tx beams, etc.) to build up the training datasets at the gNB and/or assist in the training of the AIML model(s) at the gNB. The configuration for performance monitoring and mechanisms for fallback to legacy procedures (e.g., setting of performance thresholds at the gNB) may be done during the initial AIML model configuration. An initial model configuration may be at the WTRU (e.g., the model may come from a WTRU vendor) with an initial model ID (e.g., which may be set by the WTRU vendor). The WTRU may be configured with rules to perform various stages of model registration, as described herein.

The WTRU may determine to activate and/or deactivate an AIML model and send an indication to the gNB (e.g., via MAC CE). Motivations for activation may include any of one or more determinations. For example, a WTRU may determine to activate if the WTRU determines that the AIML model at the WTRU may provide better performance than a legacy RAN procedure. For example, a WTRU may determine to activate if the WTRU determines that the training of the AIML model has reached a certain configured level of convergence and is ready to be used/deployed. For example, a WTRU may determine to activate if the WTRU determines (e.g., through an indication from the gNB) that gNB may have an AIML model that may be able to provide better performance compared to legacy RAN procedure, the WTRU subsequently requests for model transfer/download from the gNB. For example, a WTRU may determine to activate if the WTRU has determined that the AIML model usage may allow overhead reduction (e.g., fewer number of reference signals from gNB required during inference/deployment, fewer number of UL signaling such as measurement report to be sent if the AIML model is employed, and the like). For example, a WTRU may determine to activate if the WTRU has decided to prioritize one RAN function associated with a given model over another for AIML operation. For example, a WTRU may determine to activate if the WTRU is not configured with a legacy RAN function and requires an AIML model for RAN functionality.

Motivations for deactivation may include any of one or more determinations. For example, a WTRU may determine to deactivate if the WTRU has determined that model performance is below a performance threshold configured by gNB. For example, a WTRU may determine to deactivate if the WTRU has determined that the WTRU may not handle ML model training overhead (e.g., computation, training time, (re)training frequency). For example, a WTRU may determine to deactivate if the WTRU has determined that the WTRU has deprioritized one RAN function associated with a given model over another for AIML operation (e.g., if the WTRU is limited with the number of AIML models it may support).

The activation/deactivation may be a final decision by the WTRU (e.g., the WTRU stops using the model in the case of deactivation and starts using the model in the case of activation immediately upon determining to activate or deactivate an AIML model).

The activation/deactivation may be a request sent to the gNB and may become effective on a positive response from the network.

The activation/deactivation may be a request sent to the gNB and may become ineffective (e.g., the model remains active if the determination was to deactivate it or the model remains inactive if the determination was to activate it) if a negative response is received from the network.

The activation/deactivation may be a request sent to the gNB and may become ineffective if a positive response is not received from the network within a given configured time.

The activation/deactivation may be a request sent to the gNB and may become effective if a negative response is not received from the network within a given configured time.

The activation/deactivation may concern multiple models. For example, the MAC CE may be a bitmap field in which activation is indicated by 1 and deactivation is indicated by 0. The specific bitmap location may be pre-configured (assigned) to a specific model ID.

The response to the activation/deactivation request from the gNB may be a negative or positive response that is applicable to all the indicated models.

The response to the activation/deactivation request from the gNB may be specific to each indicated model. For example, a response MAC CE may be sent by the gNB containing a bitmap corresponding to the received request MAC CE, in which a 0 indicates the request has been rejected for that particular model ID that is associated with that bitmap field, and a 1 indicates the request has been accepted for that particular model ID that is associated with that bitmap field.

The acceptance or rejection from the network may contain associated timing information (e.g., activation allowed after x seconds/milliseconds). The timing information may be indicated for all the models indicated in the request, or different times may be specified/indicated for each model.

The time to wait before applying the activation or deactivation may be pre-configured before the activation/deactivation request is sent. For example, the time to wait may be configured during the model registration, configuration, and/or update procedure. The time to wait may be configured at a WTRU level and may be applicable to all models.

A prohibit timer may be defined to limit the frequency of activations/deactivations. The prohibit timer may be per activation/deactivation request, regardless of which model or models are being activated or deactivated, or there may be a prohibit timer associated with each model. The WTRU may start the prohibit timer upon sending an activation/deactivation indication or request and is not allowed to send another activation/deactivation indication while the prohibit timer is running (e.g., for a selected one or more model(s) or all models, depending on whether the prohibit timer is applicable to all models or specific to one or a selected number of model(s)). Different prohibit timers may be specified for sending consecutive deactivation indications/requests, for sending consecutive activation indications/requests, for sending an activation indication/request after a deactivation indication/request, or for sending a deactivation indication/request after an activation indication/request.

The gNB may also activate/deactivate AIML models due to similar motivations as those for the WTRU. The WTRU may subsequently receive indications from the gNB on the model activation/deactivation (e.g., via MAC CE). As in the case of a WTRU initiated activation/deactivation indication, the activation/indication message (e.g., MAC CE) may contain information about multiple models at once (e.g., activating some, deactivating some). Indications may be accompanied by a time duration for which activation/deactivation may be valid. Indications may be accompanied by a wait out time, after which the activation/deactivation becomes effective.

The network alone may activate/deactivate a given model. Alternatively, the WTRU alone may activate/deactivate a given model. Moreover, both the WTRU and the network may activate/deactivate a given model. Some of the models may be activated/deactivated only by the WTRU, some of the models may be activated/deactivated by the network, and some of the models may be activated/deactivated by both the WTRU and the network.

The WTRU may be configured to monitor performance for AIML models. The WTRU may measure and/or report performance of the AIML model which is actively used for inference. The WTRU may monitor performance of active AIML models by default unless configured otherwise by the gNB. The WTRU may be optionally configured to do performance monitoring for AIML models that are not currently used for inference.

The WTRU may be configured to monitor performance of AIML models based on activation/deactivation signaling. The model identity may identify the models for performance monitoring. The WTRU may be configured to report the performance of different AIML models. The WTRU may optionally indicate the model identity in the associated performance report. An AIML capable WTRU may receive configuration information from the gNB/NW to monitor model performance.

An AIML capable WTRU may perform model performance monitoring of any one or more active AIML models. The WTRU may be configured with a set of performance metrics (KPIs) by the network, including but not limited to normalized mean squared error (NMSE), cosine similarity, and the like.

The KPIs used by the WTRU may be specific to the RAN function for which the model is deployed. For example, in a beam management use case, one KPI may be the number of times there is a disparity between a predicted “best” beam by the AIML model and the actual beam with the highest L1-RSRP measurement.

The WTRU may receive reference signals from the gNB to evaluate the performance of the AIML model (e.g., CSI-RS, SRS). For example, if the performance of the AIML model is managed by the gNB, the periodicity of receiving the reference signals from the gNB may be determined by the gNB. In another example, if the model performance is managed by the WTRU and reported to the gNB, the WTRU may determine the periodicity to request reference signals from the gNB.

The WTRU may receive explicit requests from the gNB on which one or multiple KPIs to use for model monitoring as part of the performance monitoring configuration that the WTRU may receive from the gNB.

The WTRU may be configured with associations (e.g., from a look-up table) associating KPIs with scenarios/functions. For example, a model doing CSI prediction may always be evaluated using cosine similarity.

The WTRU may receive thresholds from the gNB corresponding to the received KPIs such that the model performance has to exceed the threshold to be assigned a model version ID. The WTRU may still assign a model version ID to the AIML model, with the ID reflecting the fact that the model does not meet performance metrics. The WTRU may assign an intermediary model version ID to the AIML model to reflect that model performance is not within acceptable standards by the gNB. The AIML model performance may not be reflected in the model version ID such that if the model does not meet performance thresholds, the WTRU may send separate indications to the gNB to report poor performance.

The gNB may optionally configure performance monitoring for AIML models as well as the performance monitoring configuration (e.g., KPIs, methods to use for performance monitoring) that are not currently used for inference. The non-active AIML models may be backup AIML models or new AIML models that may be deployed (e.g., made active) in the future.

A configuration for performance monitoring and/or reporting received by the WTRU may include cases when the WTRU capabilities have been exceeded (e.g., from using multiple AIML models with high computation load). For example, the WTRU may be configured to assess/prioritize the RAN function which may benefit the most from AIML models. For example, the WTRU may select the AIML model with the best measured performance.

The WTRU may be configured to report performance results to the gNB following the performance assessment of the model. The WTRU may be configured to report the performance following every assessment instant. The WTRU may be configured to report results periodically with periodicity set by the gNB. The WTRU may be configured to report performance only if performance falls below a preconfigured performance threshold. The WTRU may be configured to report performance if performance remains below performance thresholds for a duration longer than a time threshold.

The WTRU may be configured for updating a AIML model after WTRU based online and/or offline training. The WTRU may receive a AIML model that the WTRU may train, retrain, and/or update. Once a WTRU receives a AIML model, the WTRU may train the model if untrained, or the WTRU may choose to directly use a pre-trained AIML model or retrain the whole or a part of the received AIML model. In some cases, direct usage of a pre-trained AIML model may not result in a model version ID update. In some cases, any complete, partial training, retraining, and/or update of the AIML model may result in an update to at least part of the model version ID.

The WTRU may establish that a received trained AIML model is not directly suitable for immediate usage (e.g., the model may have been trained in different channel conditions). The WTRU may receive a trained AIML model along with some training parameters (e.g., channel conditions the model was trained on, BWP, position, and velocity). The training parameters may not form part of the model version ID. Instead, the AIML model may be shared along with training parameters, which together may constitute a AIML model profile. One or more training parameters may be incorporated into the model ID. For example, the most important training parameter may be incorporated into the model ID. If the WTRU training was done in one frequency band (e.g., FR1), the AIML model may not deliver results in another frequency band (e.g., FR2). As such, a frequency band may be a field incorporated into the model ID. The WTRU may determine to retrain the AIML model using suitable channel conditions and subsequently update the model version ID. The WTRU may determine to send the AIML model back to the gNB without any update to the model version ID.

Even though the received model may not be suitable for direct deployment, parts of the model may be directly utilized for inference and/or (re)training purposes. Any complete/partial (re)training of the model may result in an update to at least part of the model version ID.

The WTRU may assign a different version number to different updates to the same AIML model. For example, the update may result from the training procedure (e.g., the AIML model needs to converge within KPI thresholds from gNB for WTRU to assign a version number to the model). A AIML model may be trained, but convergence may not be achieved. In such a case, the AIML model may not be assigned a model version ID, or the model may be assigned an intermediary model version ID, depending on the configuration at the WTRU and/or indications from the network.

The WTRU, following model training, retraining, and/or update, may be configured to select a version number within a version number space configured by the gNB.

The WTRU, following model training, retraining, and/or update, may be configured to request a new model version ID to assign to the trained, retrained, and/or updated AIML model.

The WTRU, following model training, retraining, and/or update, may assign a model version ID to the trained, retrained, and/or updated AIML model and inform the gNB about the new version ID. In case of conflict (whereby another WTRU may have used the same version and/or part thereof), the WTRU may receive a request from the gNB to update the conflicted version number or part thereof.

The WTRU may be configured with a version number format that consists of more than one part that may be of different types. For example, the different part types may include a static part and a dynamic part, a WTRU-specific part and a model-specific part, a global part and a local part, and/or a frozen part and a trainable part.

The WTRU may be configured to train and/or retrain a portion of the AIML model (e.g., a number of layers (i.e., N1) that differ from a baseline N-layer model). Once the training at the WTRU is completed and an indication that training has been completed has been sent to the gNB, the gNB may send a request to the WTRU to send the AIML model or a portion thereof to the gNB. The WTRU may be requested to share the trained model parameters and some statistics about the training data conditions with the gNB. The training data conditions may include channel conditions under which the model was trained (e.g., doppler spread, delay spread, number of multipaths, channel coherence time, channel coherence bandwidth, etc.). For example, if the WTRU has trained and/or utilized an existing AIML model received from the gNB and a part of the base model received from the gNB was already trained (e.g., the last N1 layers) while other layers (e.g., the first N-N1 layers) were kept constant or frozen, then the WTRU may indicate to the gNB that only a part of the AIML model was retrained and share the weights corresponding to the trained layers (e.g., last N1 layers).

The WTRU, following training, retraining, and/or updating of a part of a AIML model, may be configured to update the entire or a portion (e.g., only certain fields) of a model version ID and send it back to the gNB/NW.

The WTRU, following training, retraining, and/or updating of a part of a AIML model, may send to the gNB an indication that training has been done along with the original version ID of the AIML model, leaving it to the gNB to update the model version ID and/or assign a new/updated model version ID to the trained AIML model or part thereof. A part of the indication may include metadata about the AIML model (e.g., the number of layers that were updated) and the training conditions (e.g., channel conditions).

The WTRU may be configured to update a AIML model after a joint WTRU-gNB training. The WTRU may update its AIML model based on joint training with a peer AIML model at the gNB. If the joint training is successful, the WTRU may receive an updated model identity from the gNB. The WTRU may be configured to reuse the same model ID used before the joint training. The WTRU may be configured to delete the old AIML model if the model ID remains the same before and after the joint training. The WTRU may implicitly assume successful model registration if the gNB indicates a successful joint training.

The WTRU may be configured to handle model registration during a model transfer from the NW. For example, the WTRU may receive one or more AIML models from the gNB/network. The WTRU may be configured to perform model verification upon receiving AIML models from the gNB. The WTRU may indicate to the network the result of the model verification. The WTRU may receive AIML model identity assignments for transferred AIML models upon successful model verification.

The WTRU may be configured to handle AIML model registration during a AIML model transfer from an external server. For example, the WTRU may receive one or more AIML models from the WTRU vendor. The WTRU vendor may add new AIML models or may update/replace existing AIML models with new AIML models. The WTRU may be configured to initiate a model registration procedure in both cases. The WTRU may indicate the type of registration (e.g., new or updated). An example registration procedure may involve capability exchange, model verification, and/or model ID assignment, as described herein.

The WTRU may be configured for AIML model registration, AIML model performance monitoring, AIML model activation and/or deactivation, AIML model selection, and/or AIML model suitability. The WTRU may be configured for AIML model registration, which may include one or more of a capability exchange, an AIML model verification, and an AIML model identity assignment. The WTRU may be configured to configure registered AIML models for inference. The WTRU may be configured for performance monitoring of AIML models. The WTRU may be configured for handling model registration after a model update. The WTRU may be configured for handling model registration during model transfer from the NW. The WTRU may be configured for handling model registration during model transfer from an external server.

The local may correspond to basic information identifying the AIML model. The basic information of the local LCM stage reporting identification (ID) granularity may identify a function of the AIML and/or a version of the AIML model relative to a reference model. For example, the local identifier may identify the model with respect to one cell and/or group of cells and/or tracking area, and involve lower overhead than its global model ID counterpart.

The global LCM stage reporting ID granularity may comprise the basic information to uniquely identify the AIML model and additional information corresponding to the AIML model. For example, the global model ID may contain additional information/details to enable unique identification of the model (e.g., at the network). As a result, the global model ID may be more lengthy and/or consist of a larger number of fields than the local model ID.

The additional information of the global LCM stage reporting ID granularity may correspond to one or more of RAN functions/sub-functions, (sub)functionalities, (sub)features, feature groups, use cases, scenarios, training, and/or a layer grouping within the AIML model.

The additional information may correspond to an association between the AIML model and one or more other AIML models.

The additional information may further correspond to specific layers within the AIML model.

For example, the additional information of the global LCM stage reporting ID granularity may correspond to a defined cell area or a tracking area within which the WTRU may implement the AIML model and/or any information allowing the unique identification of the model, e.g., information on any one or more of the following: model input (type/format/size), model output (type/format/size), model vendor info, model version, required AIML capability to deploy model, applicable scenario/configuration/site where model was trained/may be deployed, computational complexity of the model (e.g., FLOPs, level of pre-/post-processing), model size, model performance, model functionality, model monitoring method(s), etc.

The WTRU may receive an indication to switch from a lower granularity reporting of AIML LCM stage feedback to a higher granularity reporting of AIML LCM stage feedback.

For example, the WTRU may receive an indication to switch from the local LCM stage reporting ID granularity to the global LCM stage reporting ID granularity for subsequent reporting of AIML LCM stages. The WTRU may use the new higher granularity for subsequent reporting of AIML LCM stages.

The switch to the global LCM stage reporting ID granularity may require additional resources to report on one or more AIML LCM stages compared to the local LCM stage reporting identification (ID) granularity.

For example, an indication received by the WTRU to switch to the global LCM stage reporting ID granularity may be necessary because some AIML LCM stages require that additional information be reported while others do not.

As another example, an indication received by the WTRU to switch to the global LCM stage reporting ID granularity may correspond to a switch in the AIML LCM stage of the AIML model implemented on the WTRU. For example, the UE may report on LCM stage feedback (e.g., model training start/end, model monitoring start/end, model switching, model activation/deactivation, etc.) using a local model ID. Following reception of an indication to switch reporting granularity (e.g., from local ID based reporting to global ID based reporting), the UE may switch to using the global model ID for reporting subsequent LCM stage feedback (e.g., to the network).

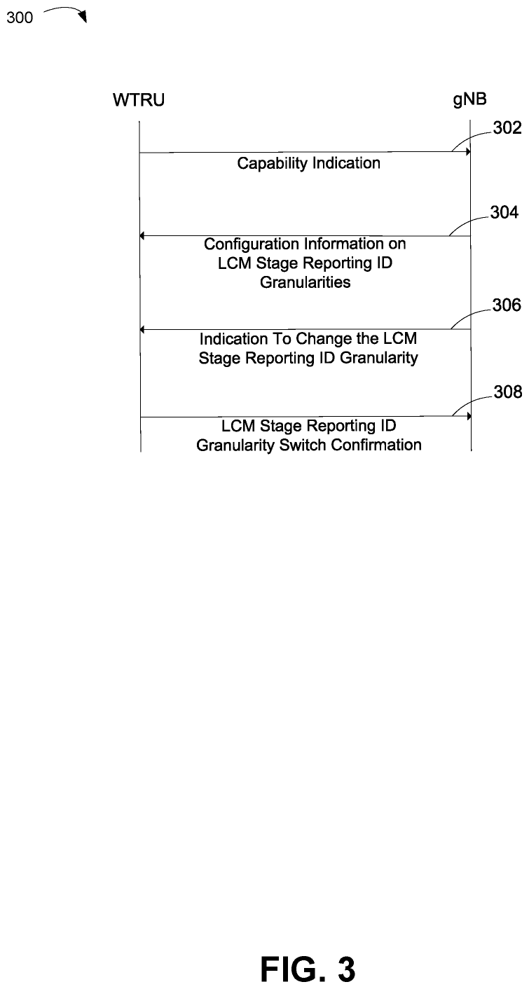

FIG. 3 is a procedure diagram illustrating an example for indicating an AIML LCM stage reporting ID granularity.

At 302, the WTRU transmits a capability indicator to the gNB. The capability indicator may include the AIML capabilities of the WTRU.

At 304, the WTRU receives a configuration information from the gMB. The configuration information may define AIML LCM stage reporting ID granularities for reporting one or more AIML LCM stages of an AIML model.

For example, the configuration information may define a local LCM stage reporting identification (ID) granularity and a global LCM stage reporting ID granularity for reporting any of the one or more AIML LCM stages of the AIML model.

For example, the AIML LCM stages of the AIML model may include model training, model monitoring, model switching, and model activation or deactivation.

At 306, the WTRU receives an indication to switch the LCM stage reporting ID granularity from the gNB.

For example, the indication may be for the WTRU to switch from the local LCM stage reporting ID granularity to the global LCM stage reporting ID granularity for the reporting of AIML LCM stage feedback.

At 308, the WTRU transmits a LCM stage reporting ID granularity switch confirmation message to the gNB.

For example, the ID granularity switch confirmation message to the gNB may confirm the switch from the local LCM stage reporting ID granularity to the global LCM stage reporting ID granularity for reporting any of the one or more AIML LCM stages.

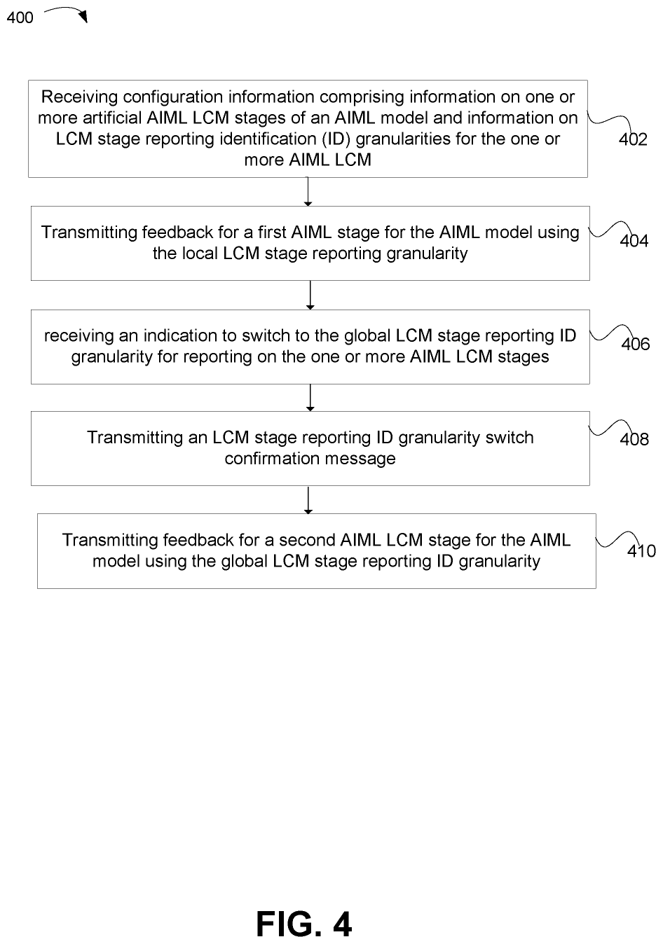

FIG. 4 is a flow chart illustrating an example method for implementing an AIML LCM stage reporting ID granularity.

In step 402, the WYRU receives configuration information comprising information on one or more AIML LCM stages of an AIML model and information on LCM stage reporting identification (ID) granularities for the one or more AIML LCM.

The one or more stages of AIML LCM stages may comprise training, monitoring, switching, and activation/deactivation of the AIML model. The LCM stage reporting ID granularities may provide a granularity for information reported on each of the AIML LCM stages. The information on AIML LCM stage reporting ID granularities may define a local LCM stage reporting ID granularity and a global LCM stage reporting ID granularity for reporting on the one or more AIML LCM stages.

The local LCM stage reporting ID granularity comprises basic information identifying the AIML model. The basic information may correspond to a function of the AIML model or to a version of the AIML model relative to a reference model.

The global LCM stage reporting ID granularity comprises basic information identifying the AIML model and additional information corresponding to the AIML model. The additional information may correspond to RAN functions/sub-functions, use cases, scenarios, training, or a layer group within the AIML model. The additional information may correspond to an association between the AIML model and one or more other AIML models and/or layers of the AIML model.

For example, the additional information may correspond to the layers of the AIML model indicating a first number of layers that are unchanged/frozen and a second number of layers whose weights may be updated as a result of training.

As a result of the difference in the granularity of the reported information, the global LCM stage reporting ID granularity is configured to utilize a different amount of resources than the local LCM stage reporting ID granularity. For example, the global LCM stage reporting ID granularity may be configured to utilize a greater amount of resources than the local LCM stage reporting ID granularity.

In step 404, the WTRU transmits feedback for a first AIML stage for the AIML model using the first LCM stage reporting granularity.

In step 406, the WTRU receives receiving an indication to switch to the global LCM stage reporting ID granularity for reporting on the one or more AIML LCM stages.

In step 408, the WTRU transmits an LCM stage reporting ID granularity switch confirmation message.

In step 410, the WTRU transmits feedback for a second AIML LCM stage for the AIML model using the global LCM stage reporting ID granularity.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, read-only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1.-20. (canceled)

21. A wireless transmit/receive unit (WTRU) comprising:
a processor configured to:
receive configuration information comprising information on one or more artificial intelligence/machine language (AIML) lifecycle management (LCM) stages associated with an AIML model and information on a local LCM stage reporting identification (ID) granularity and a global LCM stage reporting ID granularity for reporting on the one or more AIML LCM stages, wherein the global LCM stage reporting ID granularity is configured to utilize a different amount of resources than the local LCM stage reporting ID granularity;
transmit feedback for a first AIML LCM stage for the AIML model using the local LCM stage reporting ID granularity;
receive an indication to switch to the global LCM stage reporting ID granularity for reporting on the one or more AIML LCM stages;
transmit an LCM stage reporting ID granularity switch confirmation message; and
transmit feedback for a second AIML LCM stage for the AIML model using the global LCM stage reporting ID granularity.

22. The WTRU of claim 1, wherein the one or more stages of AIML LCM stages comprises training, monitoring, switching, and activation/deactivation of the AIML model.

23. The WTRU of claim 21, wherein the local LCM stage reporting ID granularity comprises basic information to identify the AIML model, wherein the basic information comprises a model ID associated with the AIML model, and wherein the processor is configured to identify the AIML model based at least on the model ID.

24. The WTRU of claim 21, wherein the global LCM stage reporting ID granularity comprises basic information identifying the AIML model and additional information corresponding to the AIML model, wherein a model ID structure comprises the basic information and the additional information, and wherein the AIML model is identified based on the additional information.

25. The WTRU of claim 24, wherein the basic information identifies a function of the AIML model or a version of the AIML model relative to a reference model.

26. The WTRU of claim 24, wherein the additional information corresponds to one or more of radio access network (RAN) functions or sub-functions, use cases, scenarios, or training, and wherein the additional information identifies an association between the AIML model and one or more other AIML models.

27. The WTRU of claim 24, wherein the additional information comprises information corresponding to a layer grouping within the AIML model.

28. The WTRU of claim 24, wherein the additional information corresponding to the layers of the AIML model indicates a first number of layers that are unchanged and a second number of layers whose weights may be updated as a result of training.

29. The WTRU of claim 21, wherein the processor is configured to determine to switch from the first AIML LCM stage to the second AIML LCM stage based at least on the indication.

30. The WTRU of claim 21, wherein the feedback comprises one or more of a model training start, a model training end, a model monitoring start, a model monitoring end, model switching, a model activation, or a model deactivation.

31. A method performed by wireless transmit/receive unit (WTRU), the method comprising:
receiving configuration information comprising information on one or more artificial intelligence/machine language (AIML) lifecycle management (LCM) stages associated with an AIML model and information on a local LCM stage reporting identification (ID) granularity and a global LCM stage reporting ID granularity for reporting on the one or more AIML LCM stages, wherein the global LCM stage reporting ID granularity is configured to utilize a different amount of resources than the local LCM stage reporting ID granularity;
transmitting feedback for a first AIML LCM stage for the AIML model using the local LCM stage reporting ID granularity;
receiving an indication to switch to the global LCM stage reporting ID granularity for reporting on the one or more AIML LCM stages;
transmitting an LCM stage reporting ID granularity switch confirmation message; and
transmitting feedback for a second AIML LCM stage for the AIML model using the global LCM stage reporting ID granularity.

32. The method of claim 31, wherein the one or more stages of AIML LCM stages comprises training, monitoring, switching, and activation/deactivation of the AIML model.

33. The method of claim 31, wherein the local LCM stage reporting ID granularity comprises basic information to identify the AIML model, wherein the basic information comprises a model ID associated with the AIML model, and wherein the AIML model is identified based at least on the model ID.

34. The method of claim 31, wherein the global LCM stage reporting ID granularity comprises basic information identifying the AIML model and additional information corresponding to the AIML model, wherein a model ID structure comprises the basic information and the additional information, and wherein the AIML model is identified based on the additional information.

35. The method of claim 34, wherein the basic information identifies a function of the AIML model or a version of the AIML model relative to a reference model.

36. The method of claim 34, wherein the additional information corresponds to one or more of radio access network (RAN) functions or sub-functions, use cases, scenarios, or training, and wherein the additional information identifies an association between the AIML model and one or more other AIML models.

37. The method of claim 34, wherein the additional information comprises information corresponding to a layer grouping within the AIML model.

38. The method of claim 34, wherein the additional information corresponding to the layers of the AIML model indicates a first number of layers that are unchanged and a second number of layers whose weights may be updated as a result of training.

39. The method of claim 31, further comprising determining to switch from the first AIML LCM stage to the second AIML LCM stage based at least on the indication.

40. The method of claim 31, wherein the feedback comprises one or more of a model training start, a model training end, a model monitoring start, a model monitoring end, model switching, a model activation, or a model deactivation.
